(19) United States
(12) Patent Application Publication
(10) Pub. No.: US 2019/0373878 A1
(43) Pub. Date: Dec. 12, 2019

(54) FISH RETRIEVAL ASSEMBLY

(71) Applicants: Mark Liebl, Hanska, MN (US); Tammy Weller, Hanska, MN (US)

(72) Inventors: Mark Liebl, Hanska, MN (US); Tammy Weller, Hanska, MN (US)

(21) Appl. No.: 16/005,765

(22) Filed: Jun. 12, 2018

(51) Int. Cl. A01K 97/01

(52) U.S. Cl. CPC A01K 97/01

(57) ABSTRACT

A fish retrieval assembly for retrieving a fish during ice fishing includes a rod that is extendable downwardly into an ice fishing hole. A pivot unit is provided and the rod is rotatably coupled to the pivot unit. The pivot unit engages the ice to retain the rod in the ice fishing hole and the pivot unit biases the rod upwardly. A foraminous plate is coupled to the rod. The rod lifts the foraminous plate against a lower surface of the ice to keep the ice fishing hole unobstructed. The rod lifts the foraminous plate upwardly in the ice fishing hole thereby lifting a fish upwardly in the ice fishing hole for retrieval.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to retrieval devices and more particularly pertains to a new retrieval device for retrieving a fish during ice fishing.

### BRIEF SUMMARY OF THE INVENTION

An embodiment of the disclosure meets the needs presented above by generally comprising a rod that is extendable downwardly into an ice fishing hole. A pivot unit is provided and the rod is rotatably coupled to the pivot unit. The pivot unit engages the ice to retain the rod in the ice fishing hole and the pivot unit biases the rod upwardly.

a foraminous plate is coupled to the rod. The rod lifts the foraminous plate against a lower surface of the ice to keep the ice fishing hole unobstructed. The rod lifts the foraminous plate upwardly in the ice fishing hole thereby lifting a fish upwardly in the ice fishing hole for retrieval.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fish retrieval assembly according to an embodiment of the disclosure.

FIG. 2 is a right side view of an embodiment of the disclosure.

FIG. 3 is a top view of an embodiment of the disclosure.

FIG. 4 is a perspective in-use view of an embodiment of the disclosure showing a rod being positioned between a first position and a second position.

FIG. 5 is a top perspective in-use view of an embodiment of the disclosure.

### DETAILED DESCRIPTION OF THE INVENTION

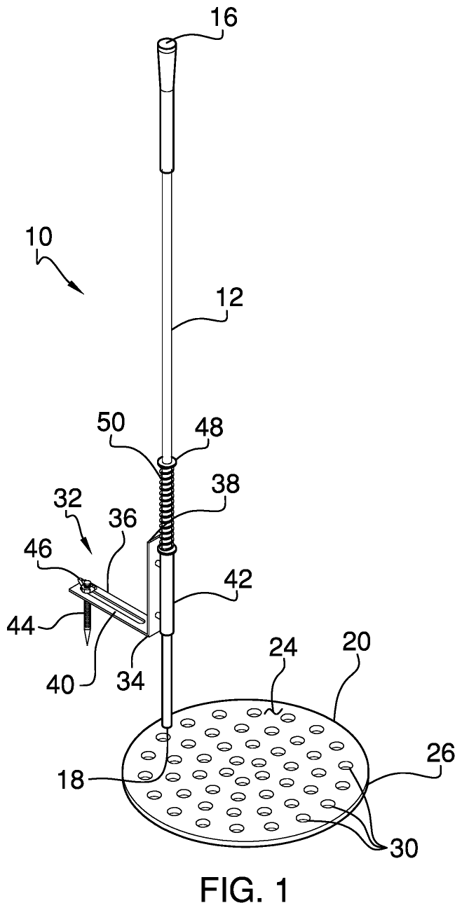

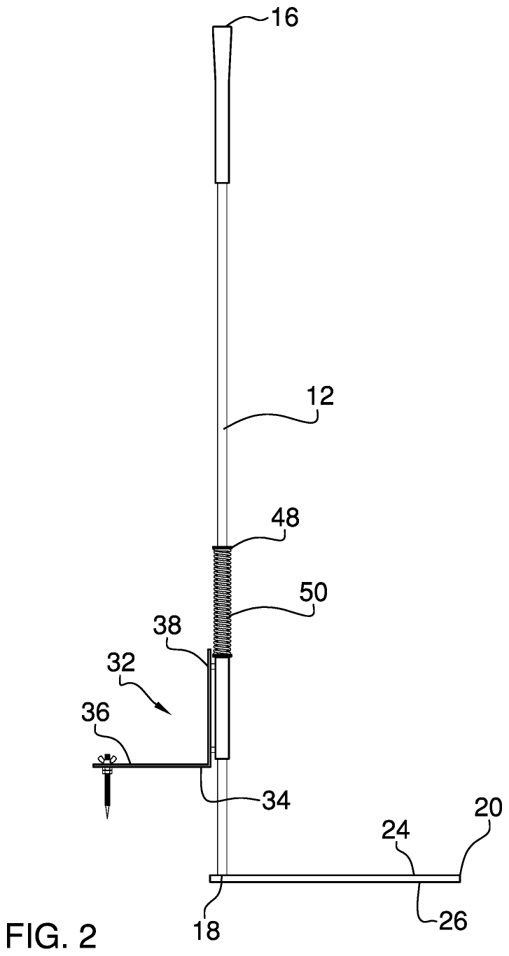

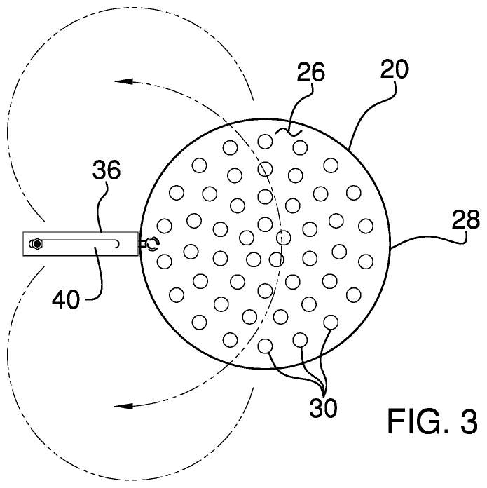

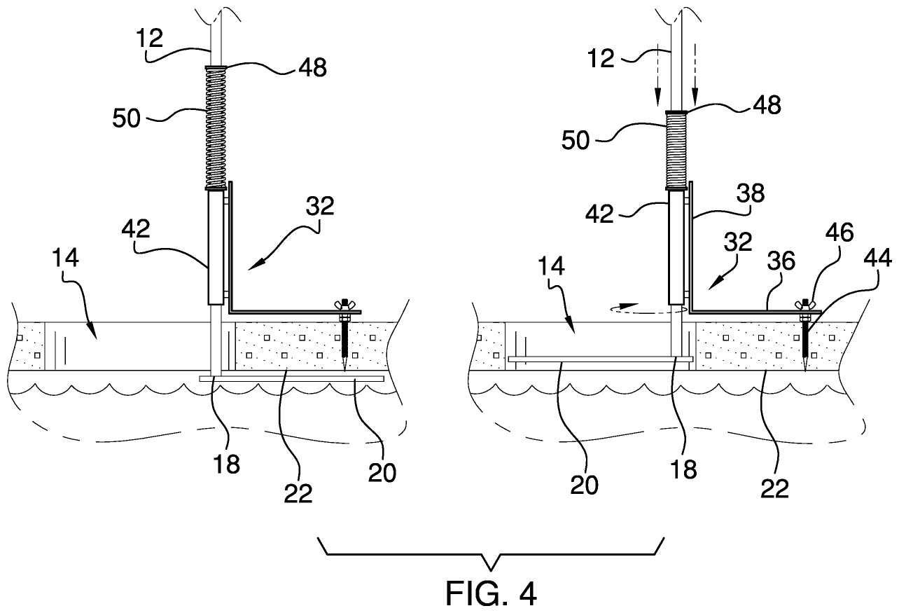

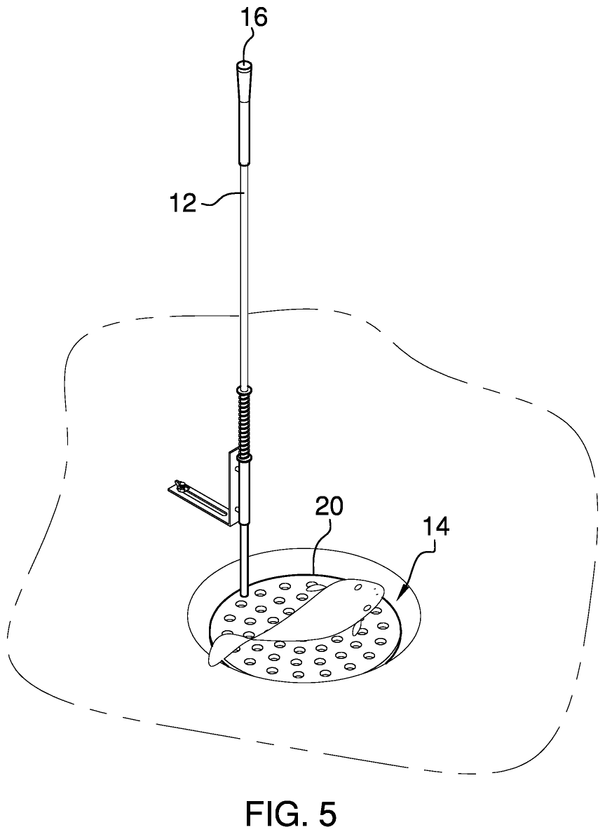

With reference now to the drawings, and in particular to FIGS. 1 through 5 thereof, a new retrieval device embodying the principles and concepts of an embodiment of the disclosure and generally designated by the reference numeral 10 will be described.

As best illustrated in FIGS. 1 through 5, the fish retrieval assembly 10 generally comprises a rod 12 that is extendable downwardly into an ice fishing hole 14. The rod 12 has a first end 16 and a second end 18 and the rod 12 is elongated between the first 16 and second 18 ends. Moreover, the rod 12 is elongated sufficiently that the first end 16 of the rod 12 is exposed above the ice when the rod 12 is extended downwardly into the ice fishing hole 14. A foraminous plate 20 is coupled to the rod 12 and the foraminous plate 20 lies on a plane that is oriented perpendicular to a longitudinal axis of the rod 12. Thus, the foraminous plate 20 is horizontally oriented when the rod 12 is extended into the ice fishing hole 14.

The rod 12 is rotatable into a first position having the foraminous plate 20 being positioned beneath a lower surface 22 of the ice and being displaced from the ice fishing hole 14. In this way the foraminous plate 20 is positioned to facilitate normal fishing activities in the ice fishing hole 14. The rod 12 is rotatable into a second position having the foraminous plate 20 being aligned with the ice fishing hole 14 and having the rod 12 being urged upwardly. In this way the foraminous plate 20 can urge a fish upwardly out of the ice fishing hole 14 for retrieval. Moreover, the foraminous plate 20 reduces the likelihood of breaking a fishing line during retrieval and reduces the need for a fisherman to put his or her hands into the water for retrieving the fish.

The foraminous plate 20 has a top surface 24, a bottom surface 26 and a peripheral edge 28 extending therebetween. The foraminous plate 20 has a plurality of apertures 30 each extending through the top 24 and bottom 26 surfaces for draining water through the foraminous plate 20. Additionally, the second end 18 of the rod 12 is coupled to the top surface 24 and the rod 12 is aligned with the peripheral edge 28 of the foraminous plate 20. The foraminous plate 20 may have a diameter ranging between approximately 6.0 inches and 8.0 inches.

A pivot unit 32 is provided and the rod 12 is rotatably coupled to the pivot unit 32. The pivot unit 32 engages the ice to retain the rod 12 in the ice fishing hole 14. The pivot unit 32 comprises a bracket 34 that has a first portion 36 forming an angle with a second portion 38. The first portion 36 has a slot 40 extending therethrough and the slot 40 is longitudinally oriented on the first portion 36.

A receiver 42 is coupled to the second portion 38 of the bracket 34 and the receiver 42 slidably receives the rod 12 having the rod 12 being oriented collinear with the second portion 38 and having the foraminous plate 20 being spaced below the bracket 34. The rod 12 is rotatable in the receiver 42 about the longitudinal axis of the rod 12. A spike 44 is slidably coupled to the bracket 34 and the spike 44 is threaded to pierce and thusly threadably engage the ice thereby retaining the bracket 34 on the ice. A fastener 46, such as a threaded nut or the like, releasably engages the spike 44. The fastener 46 frictionally engages the first portion 36 of the bracket 34 when the fastener 46 is tightened thereby retaining the spike 44 at a selected point along the slot 40.

A stop 48 is coupled to the rod 12 and the stop 48 is positioned between the first end 16 of the rod 12 and the receiver 42. A biasing member 50 is positioned around the rod 12 and the biasing member 50 extends between the stop 48 and the receiver 42. The biasing member 50 biases the rod 12 upwardly in the receiver 42 such that the foraminous plate 20 abuts the lower surface 22 of the ice when the rod 12 is rotated into the first position. Moreover, the foraminous plate 20 is urged upwardly in the ice fishing hole 14 when the rod 12 is rotated into the second position. In this way the biasing member 50 lifts the fish upwardly in the ice fishing hole 14 for retrieval.

In use, the rod 12 is aligned with the ice fishing hole 14 such that the foraminous plate 20 is positioned in the ice fishing hole 14. The spike 44 is manipulated to engage the ice thereby coupling the bracket 34 and the receiver 42 to the ice. The rod 12 is urged downwardly in the receiver 42 and rotated into the first position thereby swinging the foraminous away from the ice fishing hole 14 and beneath the lower surface 22 of the ice. The rod 12 is released and the biasing member 50 biases the rod 12 upwardly in the receiver 42, thereby compressing the foraminous plate 20 against the lower surface 22 of the ice. The rod 12 is urged downwardly in the receiver 42 and the rod 12 is rotated into the second position when a fish is caught. The rod 12 is released and the biasing member 50 urges the rod 12 upwardly in the receiver 42 thereby facilitating the foraminous plate 20 to lift the fish upwardly in the ice fishing hole 14. In this way the fish is retrieved from the ice fishing hole 14 with minimal risk of losing the fish.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fish retrieval assembly being configured to retain a fish in an ice fishing hole thereby inhibiting loss of the fish, the assembly comprising:
a rod being extendable downwardly into an ice fishing hole;
a pivot unit having the rod being rotatably coupled thereto, the pivot unit engaging the ice to retain the rod in the ice fishing hole and biasing the rod upwardly; and
a foraminous plate being coupled to the rod, the rod lifting the foraminous plate against a lower surface of the ice to keep the ice fishing hole unobstructed, the rod lifting the foraminous plate upwardly in the ice fishing hole thereby lifting a fish upwardly in the ice fishing hole for retrieval.

2. The assembly according to claim 1 wherein:
the rod has a first end and a second end, the rod being elongated between the first and second ends such that the first end of the rod is exposed above the ice when the rod is extended downwardly into the ice fishing hole; and
the foraminous plate has a top surface, a bottom surface and a peripheral edge extending therebetween, the foraminous plate having a plurality of apertures each extending through the top and bottom surfaces for draining water through the foraminous plate, the second end of the rod being coupled to the top surface having the rod being aligned with the peripheral edge of the foraminous plate, the foraminous plate lying on a plane being oriented perpendicular to a longitudinal axis of the rod such that the foraminous plate is horizontally oriented when the rod is extended into the ice fishing hole; and
the rod is rotatable into a first position having the foraminous plate being positioned beneath the lower surface of the ice and being displaced from the ice hole wherein the foraminous plate is configured to facilitate normal fishing activities in the ice fishing hole, the rod being rotatable into a second position having the foraminous plate being aligned with the ice fishing hole and having the rod being urged upwardly wherein the foraminous plate is configured to urge the fish upwardly out of the ice fishing hole for retrieval.

3. The assembly according to claim 2, wherein:
the pivot unit comprises:
a bracket having a first portion forming an angle with a second portion, the first portion having a slot extending therethrough and being longitudinally oriented on the first portion;
a receiver being coupled to the second portion of the bracket, the receiver slidably receiving the rod having the rod being oriented collinear with the second portion and having the foraminous plate being spaced below the bracket, the rod being rotatable in the receiver about the longitudinal axis of the rod;
a spike being slidably coupled to the bracket, the spike being threaded to pierce and thusly threadably engage the ice thereby retaining the bracket on the ice; and
a fastener releasably engaging the spike, the fastener frictionally engaging the first portion of the bracket when the fastener is tightened thereby retaining the spike at a selected point along the slot.

4. The assembly according to claim 2, further comprising:
the pivot unit comprising a receiver that slidably receives the rod;
a stop being coupled to the rod, the stop being positioned between the first end of the rod and the pivot unit; and
a biasing member being positioned around the rod, the biasing member extending between the stop and the pivot unit, the biasing member biasing the rod upwardly in the receiver such that the foraminous plate abuts the lower surface of the ice when the rod is rotated into the first position, the foraminous plate being urged upwardly in the ice fishing hole when the rod is rotated into the second position wherein the biasing member is configured to lift the fish upwardly in the ice fishing hole for retrieval.

5. A fish retrieval assembly being configured to retain a fish in an ice fishing hole thereby inhibiting loss of the fish, the assembly comprising:
a rod being extendable downwardly into an ice fishing hole, the rod having a first end and a second end, the rod being elongated between the first and second ends such that the first end of the rod is exposed above the ice when the rod is extended downwardly into the ice fishing hole;
a foraminous plate being coupled to the rod, the foraminous plate lying on a plane being oriented perpendicular to a longitudinal axis of the rod such that the foraminous plate is horizontally oriented when the rod is extended into the ice fishing hole, the rod being rotatable into a first position having the foraminous plate being positioned beneath a lower surface of the ice and being displaced from the ice hole wherein the foraminous plate is configured to facilitate normal fishing activities in the ice fishing hole, the rod being rotatable into a second position having the foraminous plate being aligned with the ice fishing hole and having the rod being urged upwardly wherein the foraminous plate is configured to urge a fish upwardly out of the ice fishing hole for retrieval, the foraminous plate having a top surface, a bottom surface and a peripheral edge extending therebetween, the foraminous plate having a plurality of apertures each extending through the top and bottom surfaces for draining water through the foraminous plate, the second end of the rod being coupled to the top surface having the rod being aligned with the peripheral edge of the foraminous plate;
a pivot unit having the rod being rotatably coupled thereto, the pivot unit engaging the ice to retain the rod in the ice fishing hole, the pivot unit comprising:
a bracket having a first portion forming an angle with a second portion, the first portion having a slot extending therethrough and being longitudinally oriented on the first portion;
a receiver being coupled to the second portion of the bracket, the receiver slidably receiving the rod having the rod being oriented collinear with the second portion and having the foraminous plate being spaced below the bracket, the rod being rotatable in the receiver about the longitudinal axis of the rod;
a spike being slidably coupled to the bracket, the spike the spike being threaded to pierce and thusly threadably engage the ice thereby retaining the bracket on the ice; and
a fastener releasably engaging the spike, the fastener frictionally engaging the first portion of the bracket when the fastener is tightened thereby retaining the spike at a selected point along the slot;
a stop being coupled to the rod, the stop being positioned between the first end of the rod and the receiver; and
a biasing member being positioned around the rod, the biasing member extending between the stop and the receiver, the biasing member biasing the rod upwardly in the receiver such that the foraminous plate abuts the lower surface of the ice when the rod is rotated into the first position, the foraminous plate being urged upwardly in the ice fishing hole when the rod is rotated into the second position wherein the biasing member is configured to lift the fish upwardly in the ice fishing hole for retrieval.
